(19) United States
(12) Patent Application Publication
(10) Pub. No.: US 2018/0218395 A1
(43) Pub. Date: Aug. 2, 2018

(54) ADVERTISEMENTS TARGETING ON VIDEO PLAYLISTS

(71) Applicants: Reto Strobl, Walenstadt (CH); Razvan Constantin, Adliswil (CH)

(72) Inventors: Reto Strobl, Walenstadt (CH); Razvan Constantin, Adliswil (CH)

(73) Assignee: Google Inc., Mountain View, CA (US)

(21) Appl. No.: 13/463,673

(22) Filed: May 3, 2012

(51) Int. Cl. G06Q 30/02; H04N 21/23

(52) U.S. Cl. CPC G06Q 30/0251; H04N 21/23

(57) ABSTRACT

This disclosure includes a system and method to provide advertisements targeting media playlists. The method may include receiving a user request for a media item, identifying one or more media playlists associated with the requested media item, obtaining one or more advertisements targeting the identified media playlists, and presenting at least one of the obtained advertisements along with the requested media item to a user.

### TECHNICAL FIELD

Embodiments of the present disclosure relate to the field of online advertising and, more particularly, to advertisements targeting on video playlists.

### BACKGROUND

On the Internet, video hosting websites allow users to upload, view, and share user video content. Such video content may include content from professional content creators, e.g., movie clips, TV clips, and music videos, as well as content from amateur content creators such as video blogging and short original videos. Users can be directed to videos on a video hosting site via a Uniform Resource Locator (URL) link shared by another user, or via a search for particular content on the video hosting site.

Access to videos has enabled opportunities for improving the targeting of advertisements to receptive audiences. In particular, advertisers can select certain parameters that should trigger placement of their advertisements when relevant videos are presented to end users. One frequently used parameter is a category of video content. Advertisers are typically provided with a list of existing categories for selection. However, these categories are usually rather broad and do not provide sufficient granularity for targeting. In addition, videos are typically categorized using an automatic classifier, which may not correspond to user-perceived categorization of videos.

### SUMMARY

In some embodiments, a method to provide advertisements targeting media playlists is presented. The method includes storing, by an advertisement server, associations between media playlists and advertisements in a data store. The method further includes receiving an advertisement request pertaining to a media item, the media item being part of at least one of the selected media playlists, obtaining at least one advertisement for the media item based on the associations stored in the data store, and providing the obtained advertisement to the content providing server.

In another embodiment, a method to obtain advertisements for requested media items includes receiving, at a computing device, a user request for a media item, identifying one or more media playlists associated with the requested media item, obtaining one or more advertisements targeting the identified media playlists, and presenting at least one of the obtained advertisements along with the requested media item to a user.

In yet another embodiment, a method to determine performance scores for advertisements includes determining whether a present advertisement is associated with at least one media playlist, and predicting a performance score of the present advertisement using data pertaining to at least one media playlist.

In additional embodiments, computing devices for performing the operations described above are also implemented. Further, in some embodiments, a computer readable storage medium is provided to store instructions causing a processing device to perform the operations described above.

### BRIEF DESCRIPTION OF THE DRAWINGS

The present disclosure will be understood more fully from the detailed description given below and from the accompanying drawings of various embodiments of the disclosure.

FIG. 1 illustrates an exemplary network architecture, in accordance with one embodiment of the disclosure.

FIG. 2 is a block diagram of one embodiment of a playlist advertisement subsystem.

FIG. 3 is a block diagram of one embodiment of a media playlist manager.

FIG. 4 is a flow diagram of one embodiment of a method for associating advertisements with media playlists.

FIG. 5 illustrates an exemplary graphical user interface (GUI) for providing advertisements targeting video playlists, in accordance with some embodiments of this disclosure.

FIG. 6 is a flow diagram of one embodiment of a method for providing advertisements targeting media playlists.

FIG. 7 is a flow diagram of one embodiment of a method for obtaining advertisements for requested media items using media playlists of the requested media items.

FIG. 8 is a flow diagram of one embodiment of a method for providing advertisements associated with media items.

FIG. 9 is a flow diagram of one embodiment of a method for selecting advertisements based on performance scores.

FIG. 10 is a flow diagram of one embodiment of a method for predicting a performance score of an advertisement associated with a media playlist.

FIG. 11 is a block diagram of an exemplary computer system that may perform one or more of the operations described herein.

### DETAILED DESCRIPTION

Systems and methods to provide advertisements targeting media playlists are described. A media playlist is a user-created list of media items (e.g., movies, video clips, audio clips, etc.). For example, a user may create a video playlist including recent music videos of a certain singer, a video playlist including favorite movies of a particular genre, and so on. Media playlists are dynamic in nature (e.g., they can be updated to include more recent media items and remove outdated media items). Users can allow their media playlists to be viewed by other users by, for example, sharing media playlists on various websites (e.g., content hosting websites, social networking websites, etc.), or including media playlists in blogs, personal web pages, etc. In addition, users can search for media playlists of other users on, for example, content hosting websites or social networking websites.

Embodiments of the present disclosure expose media playlists as placements for advertisement targeting. A placement may refer to any web property that can enable the presentation of advertisements (“ads”). A web property can represent, for example, a search result page, a watch page, a website, a subset of web pages, or any other network distributed content, etc.

In one embodiment, an advertisement server allows an advertiser to select one or more media playlists as placements, and specify one or more ads targeting the selected media playlists. The advertisement server may store associations between the selected media playlists and corresponding ads in a data store. These associations may then be used to present ads when media items from corresponding media playlists are viewed by the end users.

The presentation of ads that target media playlists can be facilitated by a content hosting server, which may store data identifying media playlists created by various users and media items included in these media playlists. When the content hosting server receives a user request for a media item, the content hosting website may identify at least one media playlist that includes the requested media item, and send an advertisement request with an identifier of the media playlist to the advertisement server. The advertisement server may then determine whether this media playlist is associated with any ads in the data store. If so, the advertisement server may provide one or more ads associated with the media playlist to the content hosting website, which may present the requested media item along with the associated ad(s) to the user.

Embodiments of the present invention improve targeted advertising associated with media items by utilizing media playlists as placements for ads. A media playlist reflects user-perceived categorization of media items and is dynamic in nature, thereby providing an effective means for the targeting of ads to receptive audiences.

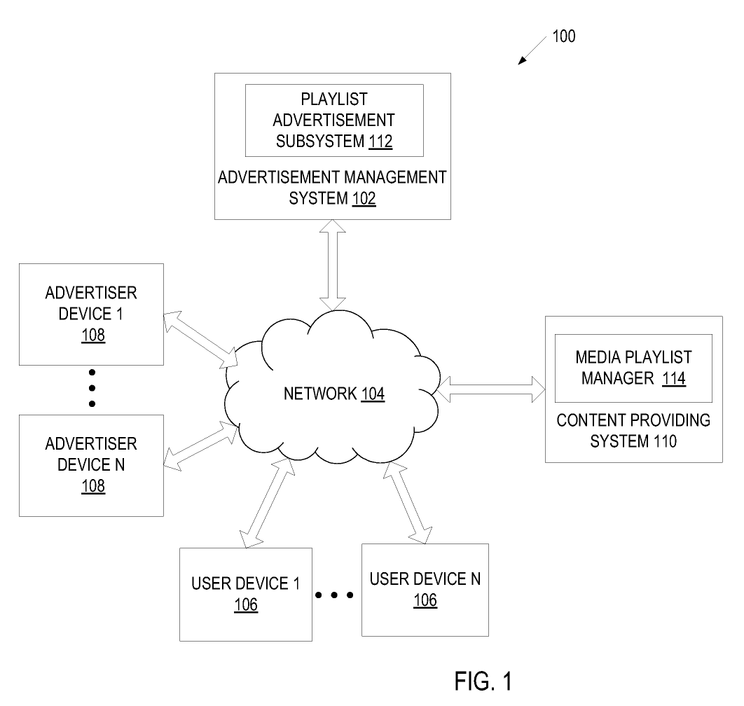

FIG. 1 illustrates an exemplary network architecture 100, in accordance with one embodiment of the present disclosure. The network architecture 100 may include an advertisement management system 102 and advertiser devices 108 coupled to the advertisement management system 102 via a network 104. In addition, the network architecture 100 may include a content providing system 110 and user devices 106 coupled to the network 104. The network 104 may include one or more local area networks (LANs), radio access networks (RANs), wide area networks (WANs), all or a portion of the global computer network known as the Internet, and/or any other communication system or systems at one or more locations.

The advertiser devices 108 and the user devices 106 may include any type of computing devices such as portable digital assistants, mobile phones, laptop computers, portable media players, tablet computers, netbooks, notebooks, desktop computers, gaming consoles, DVD players, media centers, and the like. The advertisement management system 102 and the content providing system 110 may each be hosted by one or more machines such as one or more server computer systems, routers, gateways, etc. Alternatively, the advertisement management system 102 and the content providing system 110 may be hosted by the same machine.

In some implementations, advertisers can access the advertisement management system 102 via advertiser devices 108 to enter, maintain and track advertisement information. The advertisement management system 102 may provide a list of available placements and corresponding prices for the available placements to the advertisers. An advertiser can specify one or more targeting criteria to select placements on which the advertiser would like to place the ads. The advertisement management system 102 may then store the associations between the selected placements and the corresponding ads. The ads may include graphical ads (e.g., banner ads), text only ads, image ads, audio ads, video ads, etc. The ads may also include embedded information, such as a link, meta-information, and/or machine executable instructions.

The advertisement management system 102 may receive advertisement requests from one or more content providing systems 110. A content providing system 110 may represent a video hosting website, a news content provider, a social network site, or any other entity that provides media content (e.g., video or audio content) to the user devices 106. The content providing system 110 may submit an advertisement request to the advertisement management system 102 upon receiving a media item request from a user device 106. The advertisement request submitted by the content providing system 110 may include media item request information such as an identifier of the requested media item, a category corresponding to the requested media item (e.g., business, movies, music, etc.), media item type (e.g., video, audio, etc.), media item age, geo-location information, etc.

Upon receiving an advertisement request from the content providing system 110, the advertisement management system 102 may select one or more ads matching media item request information and provide the selected ads to the content providing system 110. The content providing system 110 can combine the requested media item with one or more ads provided by the advertisement management system 102, and provide the resulting content page to the user device 106 for presentation to the user (e.g., via a web browser). In one implementation, the ads selected by the advertisement management system 102 are auctioned to determine what ads should be returned to the content providing system 110 and/or the order in which they should be presented to the user. This determination may depend on, for example, other advertisers' bids (e.g., the maximum amount an advertiser will pay per user click on an advertisement) and/or the performance scores of the ads. The performance score of an ad may be calculated based on, for example, historical click-through rates, relevance of an advertiser's ad text and keywords, an advertiser's account history, etc. In another implementation, the ads are selected by the advertisement management system 102 on a reservation basis (e.g., based on predefined conditions) without taking into account other advertisers' bids and/or the performance scores of the ads.

The content providing system 110 can return usage information to the advertisement management system 102. The usage information may include measured or observed user behavior related to requested content, such as whether a user has selected or “clicked” on a link to a requested media item. In addition or alternatively, the usage information may include measured or observed user behavior related to advertisements that have been served, such as whether a user has clicked on an ad returned by the advertisement management system 102, has been referred to the advertiser's web page, and has consummated a purchase there before leaving that web page. The usage information can further include traffic information, which contains user demographic information such as user age, location, and gender.

The advertisement management system 102 performs financial transactions, including crediting the content providing systems 110 and/or other entities associated with the placements used for advertising. The advertisement management system 102 may also charge the advertisers based on the usage information.

In one embodiment, the advertisement management system 102 includes a playlist advertisement subsystem 112 that exposes media playlists created by users as placements for advertisement targeting. Data pertaining to the media playlists may be provided to the playlist advertisement subsystem 112 by the content providing systems 110 and may include media items (e.g., movies, video clips, audio clips, etc.) included in each media playlist and one or more characteristics of the media playlist. The characteristics of the media playlist may include, for example, a media playlist type (e.g., movies, video clips, audio clips, etc.), a media playlist category (e.g., a certain topic, a certain artist, a certain genre, a certain director, a certain actor, etc.), a media playlist owner, one or more keywords associated with the content of the media playlist, the number of media items included in the media playlist, a media playlist popularity indicator (e.g., the number of users that accessed the media playlist), a media playlist viewer demographics (e.g., demographics of users that accessed the media playlist), whether media items included in the media playlist can be monetized (e.g., whether the media items can be presented with ads), etc.

An advertiser can access the advertisement management system 102 and specify media playlists as a type of placement. In response, the playlist advertisement subsystem 112 can present a list of available media playlists to the advertiser. The advertiser can then select desired media playlists based on media playlist characteristics, and specify one or more ads that should target each of the selected media playlists. The playlist advertisement subsystem 112 may store associations between the media playlists and the corresponding ads in a data store based on advertiser input provided to the playlist advertisement subsystem 112 or based on information received from another system or subsystem.

In one embodiment, the content providing system 110 includes a media playlist manager 114 that collects data pertaining to media playlists created by users of the user devices 106 and provides this data to the advertisement management server 102. Data pertaining to media playlists can be collected based on user input or obtained from other systems (not shown).

When a user device 106 sends a request for a media item to the content providing system 110, the media playlist manager 114 may identify one or more media playlists that include the requested media item, and send an advertisement request specifying the identified media playlists to the advertisement management system 102. In response, the advertisement management system 102 may find ads associated with the media playlists specified in the advertisement request and provide one or more of these ads to the content providing system 110, which combines these ads with the requested media item and provides the resulting content page to the user device 106 for presentation to the user. Alternatively, the user device 106 may identify one or more media playlists that include a requested media item and provide an advertisement request specifying the identified media playlists to the advertisement management system 102.

In some implementations, the advertisement request may also include other information about the requested media item, such as the requested media item itself, a category of the requested media item (e.g., a specific genre, actor, director, etc. if the requested media item is a movie), and/or user characteristics (e.g., language, location, age, etc.). In such implementations, the advertisement management system 102 may not only return ads associated with the relevant media playlist(s) but also ads matching other information about the requested media item. In one embodiment, the ads selected by the advertisement management system 102 are auctioned to determine what ads should be presented to the user and/or the order in which they should be presented.

In one embodiment, the media playlist manager 114 (and/or the user device 106) tracks user behavior related to ads associated with media playlists and returns data about such user behavior to the advertisement management system 102. The advertisement management system 102 may then credit the content providing system 110 (and/or the user device 106). In addition, in one embodiment, the advertisement management system 102 can credit the creators of media playlists if ads associated with their playlists were clicked on by the end users and/or resulted in a purchase on the advertiser's web page. By sharing revenues with the creators of media playlists, the advertisement management system 102 provides an incentive for users to create media playlists that may be interesting to other users in terms of media item grouping, content and quality.

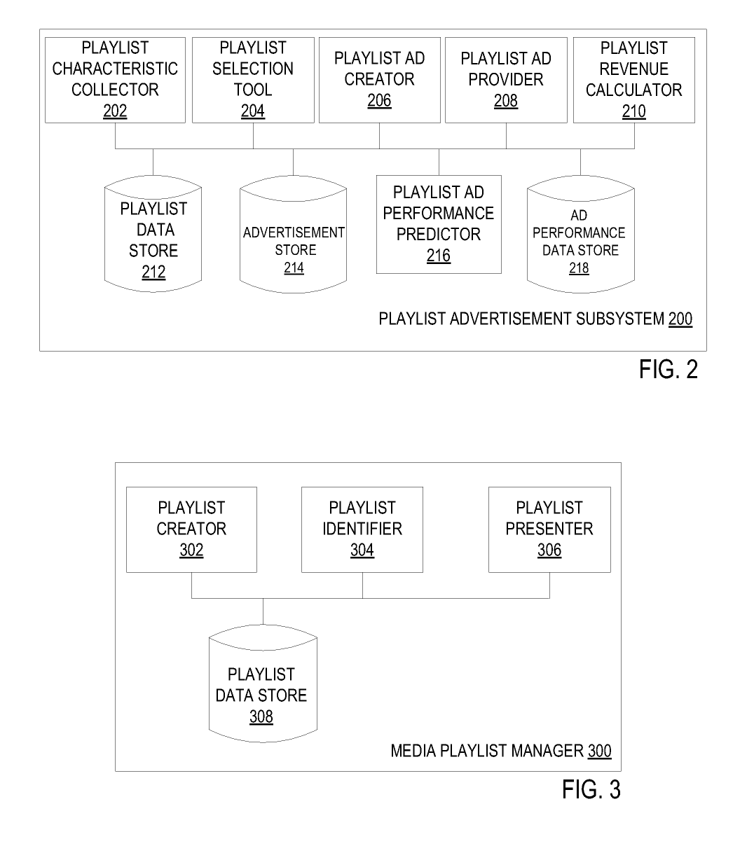

FIG. 2 is a block diagram of one embodiment of a playlist advertisement subsystem 200. The playlist advertisement subsystem 200 may be the same as the playlist advertisement system 102 of FIG. 1 and may include a playlist characteristic collector 202, a playlist selection tool 204, a playlist ad creator 206, a playlist ad provider 208, a playlist revenue calculator 210, a playlist ad performance predictor 216, a playlist data store 212, an advertisement store 214, and a playlist ad performance data store 218. The components of the playlist advertisement subsystem 200 may represent modules that can be combined together or separated into further modules, according to various embodiments. Any combination of the playlist data store 212, the advertisement store 214 and the playlist ad performance data store 218 may be part of a single data structure or each of them may represent a single data structure or multiple data structures (tables, databases, repositories, files, etc.) residing on one or more mass storage devices, such as magnetic or optical storage based disks, solid-state drives or hard drives.

The playlist characteristic collector 202 collects information about media playlists created by users of content hosting websites and other content providing systems. Information about a media playlist may identify media items included in the media playlist and include one or more characteristics of the media playlist. The characteristics of the media playlist may include, for example, a media playlist type, a media playlist category, a media playlist owner, one or more keywords associated with the content of the media playlist, the number of media items included in the media playlist, a media playlist popularity indicator, a media playlist viewer demographics, whether media items included in the media playlist can be monetized, etc. The playlist characteristic collector 202 stores the information about the media playlists in the playlist data store 212.

The playlist selection tool 204 provides a list of available media playlists to an advertiser when the advertiser selects media playlists as a type of placement. The playlist selection tool 204 may also allow the advertiser to specify one or more playlist characteristics and search for media playlists matching the specified characteristics. For example, the advertiser may specify a category (e.g., children's movies) and a minimum number of items in a media playlist (e.g., 20 movies), and the playlist selection tool 204 will return media playlists matching the specified characteristics (e.g., video playlists including at least 20 movies for children). The advertiser can then select desired media playlists from the media playlists matching the specified characteristics.

The playlist ad creator 206 receives an advertiser input specifying one or more ads (e.g., toy ads) that should target each of the selected media playlists (e.g., certain children's movies), and stores the associations between the media playlists and the ads in the advertisement store 214. These associations are then used to present ads with media items contained in corresponding media playlists. In one embodiment, the playlist ad creator 206 stores, in the advertisement store 214, an identifier of a media playlist together with an identifier of each ad targeting the media playlist. In this embodiment, if a new media item is later added to the media playlist, and this media item is subsequently requested by a user, the media item will be presented with one or more ads previously associated with the media playlist. In other words, in accordance with this embodiment, targeted advertising can be dynamically adapted to changes in the media playlists.

In another embodiment, the playlist ad creator 206 identifies all media items included in a media playlist selected by an advertiser, and stores an identifier of each media item together with identifiers of ads targeting the selected media playlist. The playlist ad creator 206 may periodically receive changes made to the media playlists (e.g., new media items added to the media playlists and existing media items deleted from the media playlists), and may update the associations in the advertisement store 214 accordingly.

In some implementations, the advertisement store 214 not only stores associations of ads with media playlists but also associations of ads with other characteristics of media items and/or users. These characteristics may include, for example, a media item name or other identifier (e.g., a URL), a media item content category, a media item type, a media item author, a media item geo-location, user demographics (e.g., age, language, time zone, occupation), etc.

The playlist ad provider 208 receives advertisement requests pertaining to media items from content providing systems and returns ads for the media items to the content providing systems. In one embodiment, a content providing system submits an advertisement request pertaining to a media item when a user selects the media item from a media playlist presented to the user, and the content providing system includes the identifier of this media playlist in the advertisement request. In another embodiment, the content providing system submits an advertisement request pertaining to a media item when a user requests the media item without first viewing a corresponding media playlist (e.g., by directly searching for the media item, entering a URL of the media item or selecting a link to the media item). In this other embodiment, the content providing system finds all media playlists containing the media item, and includes the identifiers of these media playlists in the advertisement request. In yet another embodiment, the content providing system does not include identifiers of any media playlists in the advertisement request but rather includes the identifier of the media item itself.

Upon receiving the advertisement request pertaining to the media item, the playlist ad provider 208 searches the advertisement store 214 for ads matching the advertisement request. The matching may be determined based on one or more identifiers of media playlists included in the advertisement request and/or an identifier of the media item. Additionally, in some embodiments, the matching is also determined based on other characteristics included in the advertisement request such as the media item name or URL, the media item content category, the media item type, the media item author, user demographics, etc. When all matching ads are found, all or some of these ads are returned to the content providing server. In one embodiment, the ads to be returned are selected based on their performance scores as will be discussed in more detail below. The order in which the ads should be presented to the user may also depend on their performance scores, as well as other advertisers' bids.

The playlist revenue calculator 210 receives information specifying user behavior related to ads associated with media playlists and determines which of these ads were clicked on by the end users and/or resulted in a purchase on the advertiser's web page. The playlist revenue calculator 210 then identifies the creators of such media playlists (e.g., using data in the playlist data store 212 and the advertisement store 214) and credits a share of revenue generated by such ads to the creators of corresponding media playlists.

The playlist ad performance predictor 216 calculates performance scores of ads selected for the media item by the playlist ad provider 208 and stores the calculated performance scores in the ad performance data store 218. As discussed above, the performance score of an ad is calculated using factors pertaining to the ad (e.g., a historical click-through rate of the ad, relevance of an advertiser's ad text and keywords, an advertiser's account history). In addition, the performance score of the ad may depend on whether the ad is associated with any media playlist. In one embodiment, if the playlist ad performance predictor 216 determines that an ad is associated with a media playlist, the playlist ad performance predictor 216 increases the performance score of the ad (e.g, by a predetermined number or a fraction and/or based on how many media playlists the ad is associated with) since users are likely to be more receptive to ads targeting media playlists.

FIG. 3 is a block diagram of one embodiment of a media playlist manager 300. The media playlist manager 300 may be the same as the media playlist manager 114 of FIG. 1 and may include a playlist creator 302, a playlist identifier 304, a playlist ad presenter 306 and a playlist data store 308. The components of the media playlist manager 300 may represent modules that can be combined together or separated into further modules, according to various embodiments. The playlist data store 308 may represent a single data structure or multiple data structures (tables, databases, repositories, files, etc.) residing on one or more mass storage devices, such as magnetic or optical storage based disks, solid-state drives or hard drives.

The playlist creator 302 allows users to create media playlists and stores information about media playlists in the playlist data store 308. Information about a media playlist may identify a media playlist and media items contained in the media playlist, and also include one or more characteristics of the media playlist. The characteristics of the media playlist may include, for example, a media playlist type, a media playlist category, a media playlist owner, one or more keywords associated with the content of the media playlist, the number of media items included in the media playlist, a media playlist popularity indicator, a media playlist viewer demographics, whether media items included in the media playlist can be monetized, etc. The playlist creator 302 may also update media playlist information in the playlist data store 308 when users add new media items to media playlists, remove existing media items from media playlists, or update characteristics of media playlists. In one embodiment, the playlist creator 302 provides information about media playlists to an advertisement management system (e.g., upon request or at predetermined time intervals).

The playlist identifier 304 receives requests for media items from user devices and submits advertisement requests pertaining to the media items to the advertisement management system. The playlist identifier 304 may receive a request for a media item when a user selects the media item from a media playlist presented to the user, and may include the identifier of this media playlist in the advertisement request pertaining to the media item. Alternatively, the playlist identifier 304 may receive a request for a media item when a user requests the media item without first viewing a corresponding media playlist (e.g., by directly searching for the media item, entering a URL of the media item or selecting a link to the media item), may search the playlist data store 308 to find all media playlists containing the media item, and may include the identifiers of the found media playlists in the advertisement request pertaining to the media item.

The playlist ad presenter 306 receives one or more ads from the advertisement management system, combines the requested media item with the ads, and returns the resulting content page to the user. In one embodiment, the playlist ad presenter 306 also monitors user behavior related to ads associated with media playlists, determines which of these ads were clicked on by the end users and/or resulted in a purchase on the advertiser's web page, and provides this information to the advertisement management system.

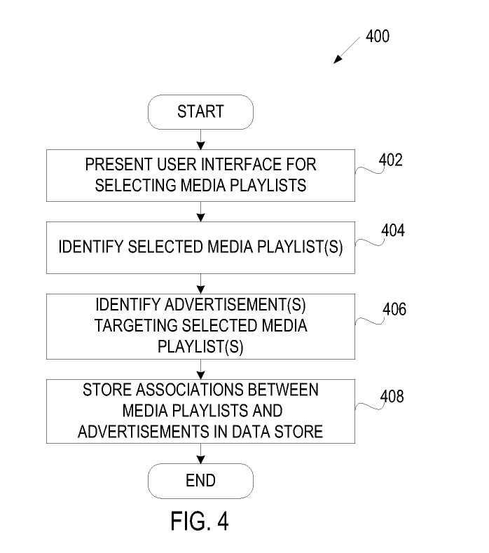

FIGS. 4, 6, 7, 8, 9 and 10 are flow diagrams of various embodiments of methods performed for providing advertisements targeting media playlists. The methods are performed by processing logic that may comprise hardware (circuitry, dedicated logic, etc.), software (such as is run on a general purpose computer system or a dedicated machine), or a combination of both.

FIG. 4 is a flow diagram of one embodiment of a method 400 for associating advertisements with media playlists. In one embodiment, method 400 is performed by an advertisement server that can represent advertisement management system 102 of FIG. 1. Alternatively, method 400 can be performed by an advertisement server in cooperation with another server or system.

Referring to FIG. 4, an advertisement server receives an advertiser's selection of media playlists as a type of placement and presents a user interface for selecting media playlists (block 402). The user interface may allow an advertiser to specify one or more media playlist characteristics (e.g., a category, a minimum number of media items, a keyword, a popularity indicator, etc.), and may present a set of media playlists matching the specified characteristics. In one embodiment, the presented set includes only media playlists containing media items that can be monetized. If a media playlist includes some but not all media items that can be monetized, the advertisement server may not include it in the set presented to the advertiser. Alternatively, the advertisement server may include such a media playlist in the set presented to the advertiser but with an indication that not all of the media items can be monetized (and optionally specifying the number of media items that cannot be monetized).

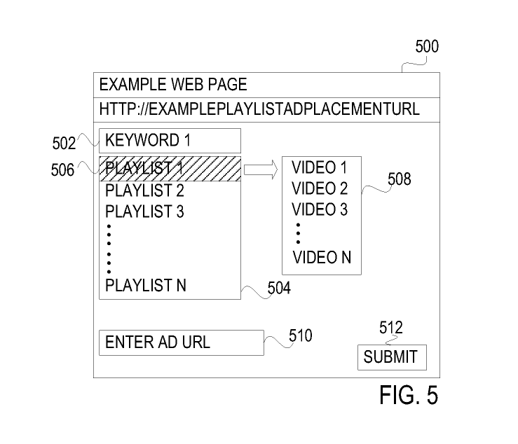

At block 404, the advertisement server allows the advertiser to select one or more media playlists from the set and identifies the selected media playlists. At block 406, the advertisement server receives user input specifying one or more ads targeting the selected media playlists. An exemplary GUI for providing ads targeting video playlists will be discussed in more detail below in conjunction with FIG. 5. Alternatively, blocks 402, 404 and 406 may be performed by an external system, which can provide associations between media playlists and advertisements to the advertisement server.

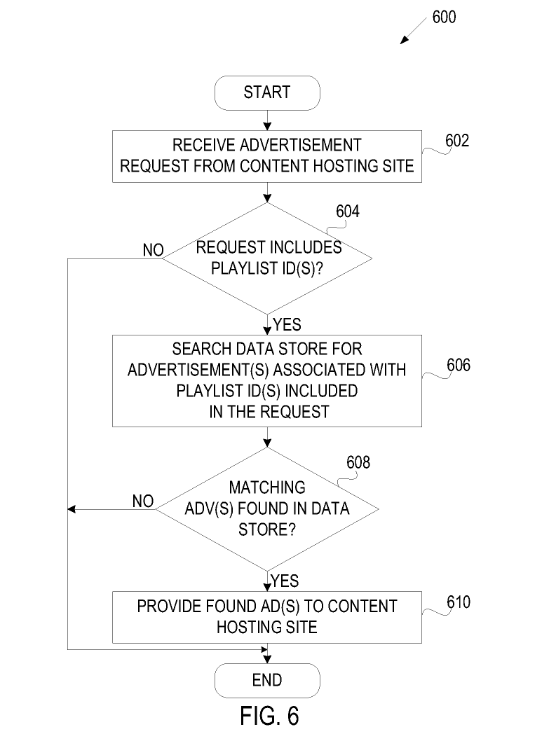

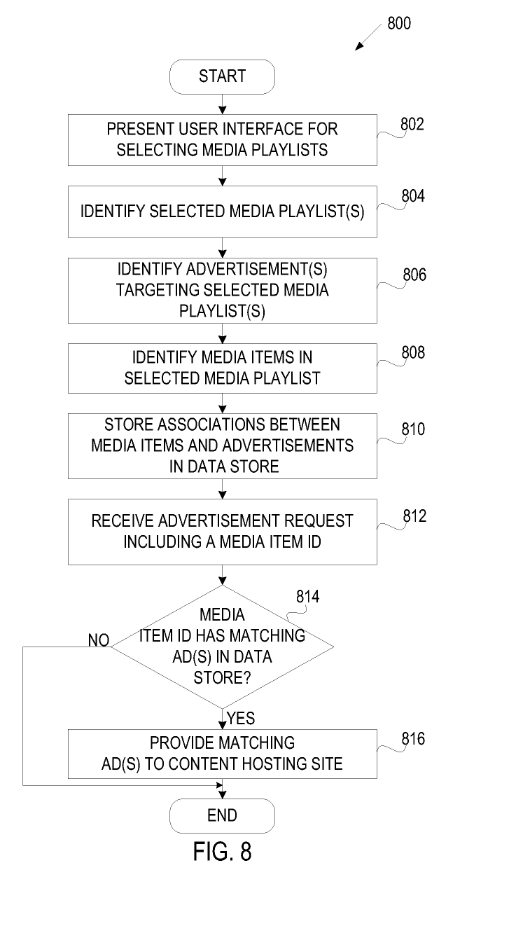

At block 408, the advertisement server stores associations between the media playlists and corresponding advertisements in a data store. In one embodiment, the advertisement server stores an identifier of a selected media playlist with an identifier of each advertisement targeting this media playlist, as will be discussed in more detail below in conjunction with FIG. 6. In another embodiment, the advertisement server identifies all media items included in the selected media playlist, and stores an identifier of each media item together with an identifier of each ad targeting the selected media playlist, as will be discussed in more detail below in conjunction with FIG. 8.

In some implementations, the advertisement server not only stores associations of ads with media playlists but also associations of ads with other characteristics of media items and/or users. These characteristics may include, for example, a media item name or other identifier (e.g., a URL), a media item content category, a media item type, a media item author, a media item geo-location, user demographics (e.g., age, language, time zone, occupation), etc. In addition, the advertisement server may also allow an advertiser to specify whether an ad should be presented with newly added media items (media items that will be added to a corresponding media playlist after an association between the ad and the media playlist has been recorded) and/or subsequently removed media items (media items that will be removed from the media playlist after the association between the ad and the media playlist has been recorded).

FIG. 5 illustrates an exemplary graphical user interface (GUI) 500 for providing advertisements targeting video playlists, in accordance with some embodiments of this disclosure. The GUI 500 may include a field 502 for specifying a keyword. When an advertiser specifies a keyword in the field 502, the GUI presents a set of video playlists 504 matching the specified keyword. An advertiser can then select a video playlist 506 from the set 504 and can view a list of videos 508 contained in the selected video playlist 506. Further, the advertiser can specify an ad 510 that should target the video playlist 508, and activate submit button 512 to record the association between the playlist 506 and the ad 510.

FIG. 6 is a flow diagram of one embodiment of a method for providing advertisements targeting media playlists. In one embodiment, method 600 is performed by an advertisement server that can represent advertisement management system 102 of FIG. 1.

Referring to FIG. 6, an advertisement server receives an advertisement request from a content hosting site (block 602) and determines whether the advertisement request identifies any media playlists (block 604). If not, method 600 ends. If so, the advertisement server searches an advertisement data store for ads associated with the media playlists identified in the advertisement request (block 606).

If the advertisement server does not find any ads associated with these media playlists in the advertisement data store (block 608), method 600 ends. Alternatively, if the advertisement server finds one or more ads associated with these media playlists in the advertisement data store, the advertisement server provides some or all of the found ads to the content hosting site (block 610).

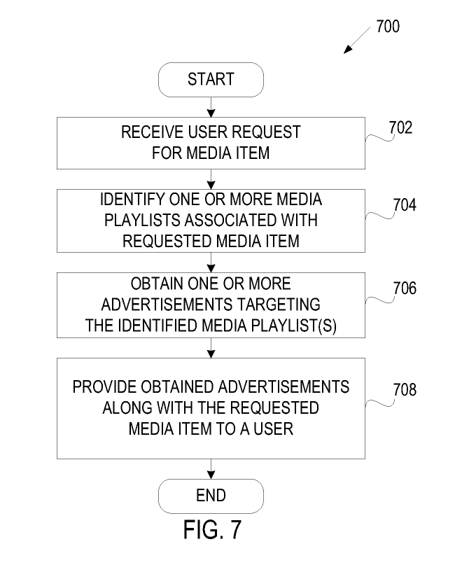

FIG. 7 is a flow diagram of one embodiment of a method for obtaining advertisements for requested media items using media playlists containing the requested media items. In one embodiment, method 700 is performed by a content providing server that can represent content providing system 110 of FIG. 1.

Referring to FIG. 7, a content providing server receives a user request for a media item. At block 704, the content providing server identifies one or more media playlists containing the media item and sends an advertisement request pertaining to the media item to the advertisement server, where the advertisement request includes identifier(s) of the media playlist(s). At block 706, the content providing server obtains one or more ads targeting the media playlist(s) from the advertisement server. At block 708, the content providing server provides the requested media item with the ad(s) targeting the corresponding media playlist(s) to the user.

FIG. 8 is a flow diagram of one embodiment of a method for providing advertisements associated with media items. In one embodiment, method 800 is performed by an advertisement server that can represent advertisement management system 102 of FIG. 1.

Referring to FIG. 8, an advertisement server presents a user interface for selecting media playlists (block 802) and identifies selected media playlists based on an advertiser's input (block 804). At block 806, for each selected media playlist, the advertisement server identifies one or more ads targeting the selected media playlist based on the advertiser's input. At block 808, the advertisement server identifies media items contained in the selected media playlist. At block 810, the advertisement server stores associations between the media items and corresponding ads in a data store. In one embodiment, the advertisement server stores an identifier of each media item together with an identifier of the ad targeting the selected media playlist, without storing an identifier of the selected media playlist. Alternatively, the advertisement server may store an identifier of a media item together with an identifier of the ad and an identifier of the selected media playlist.

At block 812, the advertisement server receives an advertisement request from a content hosting site and determines that the advertisement request identifies a media item. At block 814, the advertisement server determines whether the identified media item is associated with any ads in an advertisement data store (block 814). If not, method 800 ends. If so, the advertisement server provides at least some of these ads to the content hosting site (block 816).

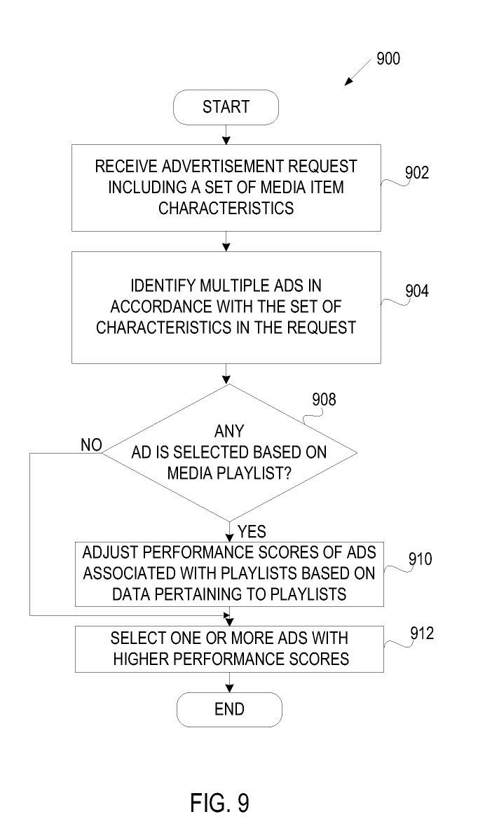

FIG. 9 is a flow diagram of one embodiment of a method for selecting advertisements based on performance scores. In one embodiment, method 900 is performed by an advertisement server that can represent advertisement management system 102 of FIG. 1.

Referring to FIG. 9, an advertisement server receives an advertisement request from a content hosting site (block 902). The advertisement request pertains to a media item and includes a set of media item characteristics including, for example, a media item name or other identifier (e.g., a URL), one or more media playlists containing the media item, a media item content category, a media item type, a media item author, a media item geo-location, user demographics (e.g., age, language, time zone, occupation), etc.

At block 904, the advertisement server finds multiple ads in an advertisement data store based on the set of media item characteristics. For example, the advertisement server may find ads 1, 2 and 3 based on the media item category, ads 4 and 5 based on the media item author, and ads 6, 7 and 8 based on the media playlists containing the media item. The advertisement server then identifies performance scores of the found ads (e.g., by obtaining these scores from ad performance data store 218).

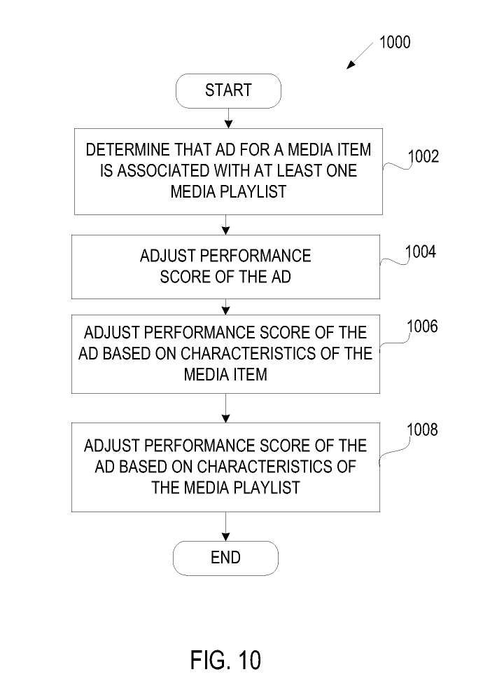

At block 908, the advertisement server determines whether any of the selected ads is associated with at least one media playlist. If not, method 900 proceeds to block 912. If so, the advertisement sever adjusts performance scores of the ads associated with media playlists (block 910). In one embodiment, the advertisement server increases the performance score of each ad associated with a media playlist (e.g, by a predetermined number or a fraction and/or based on how many media playlists the ad is associated with). One embodiment of a method for predicting a performance score of an add associated with a media playlist will be discussed in more detail below in conjunction with FIG. 10.

At block 912, the advertisement server selects one or more ads with higher performance scores and provides the selected ads to the content hosting site. The number of selected ads may be predefined or determined based on the type of content page that will present the ads. In one embodiment, the advertisement server also defines the order for presenting the ads using the performance scores and/or the bids of corresponding advertisers.

FIG. 10 is a flow diagram of one embodiment of a method for predicting a performance score of an advertisement associated with a media playlist. In one embodiment, method 1000 is performed by an advertisement server that can represent advertisement management system 102 of FIG. 1.

Referring to FIG. 10, an advertisement server determines that an advertisement for a media item is associated with at least one media playlist (block 1002) and adjusts the performance score of the ad (e.g, by incrementing it by a predetermined number or a fraction and/or based on how many media playlists the ad is associated with) (block 1004). At block 1006, the advertisement server may optionally adjust the performance score of the ad based on characteristics of the media item. For example, the advertisement server may estimate the popularity of the media item using one or more characteristics of the media item (e.g., a media item content category, a keyword, a media item type, a media item author, a media item access history, a media item geo-location, user demographics, etc.) and adjust the performance score of the ad based on the estimated popularity of the media item.

At block 1008, the advertisement server may optionally adjust the performance score of the ad based on characteristics of the media playlist. For example, the advertisement server may estimate the popularity of the media playlist using one or more characteristics of the media playlist (e.g., a media playlist type, a media playlist category, a media playlist owner, a media playlist author, a media playlist access history, user demographics, etc.) and adjust the performance score of the ad based on the estimated popularity of the media playlist.

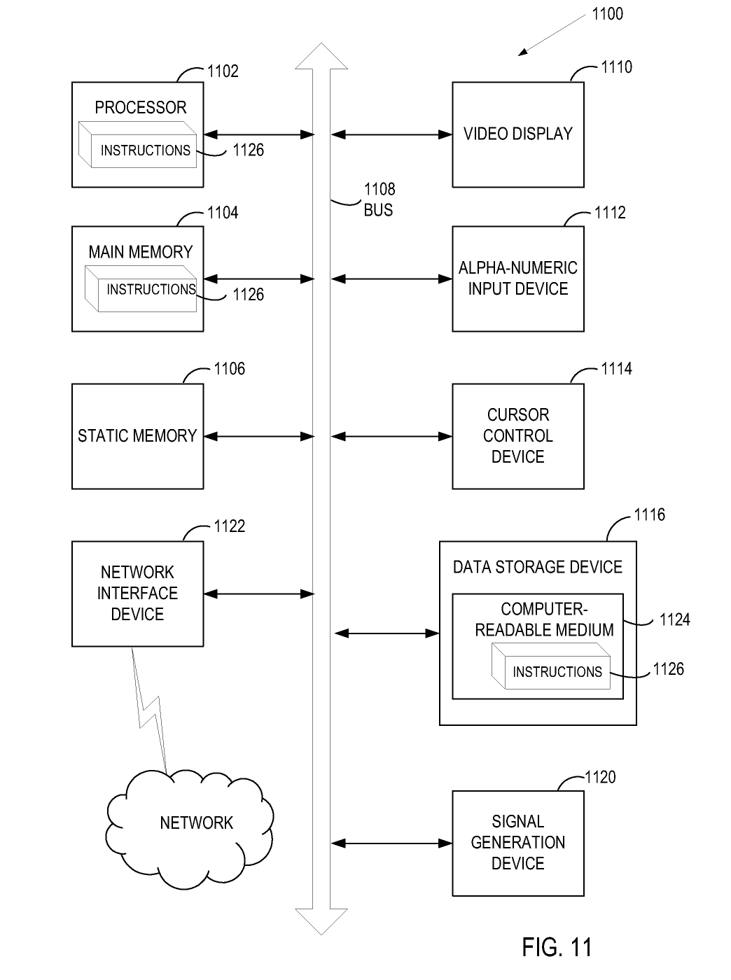

FIG. 11 illustrates a diagrammatic representation of a machine in the exemplary form of a computer system 1100 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1100 includes a processing device (processor) 1102, a main memory 1104 (e.g., read-only memory (ROM), flash memory, dynamic random access memory (DRAM) such as synchronous DRAM (SDRAM) or Rambus DRAM (RDRAM), etc.), a static memory 1106 (e.g., flash memory, static random access memory (SRAM), etc.), and a data storage device 1116, which communicate with each other via a bus 1108.

Processor 1102 represents one or more general-purpose processing devices such as a microprocessor, central processing unit, or the like. More particularly, the processor 1102 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1102 may also be one or more special-purpose processing devices such as an application specific integrated circuit (ASIC), a field programmable gate array (FPGA), a digital signal processor (DSP), network processor, or the like. The processor 1102 is configured to execute instructions of the advertisement management system 102 and/or the content providing system 110 for performing the operations and steps discussed herein.

The computer system 1100 may further include a network interface device 1122. The computer system 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse), and a signal generation device 1120 (e.g., a speaker).

The data storage device 1116 may include a computer-readable storage medium 1124 on which is stored one or more sets of instructions of the advertisement management system 102 and/or the content providing system 110 embodying any one or more of the methodologies or functions described herein. The instructions of the advertisement management system 102 and/or the content providing system 110 may also reside, completely or at least partially, within the main memory 1104 and/or within the processor 1102 during execution thereof by the computer system 1100, the main memory 1104 and the processor 1102 also constituting computer-readable storage media. The instructions 1126 may further be transmitted or received over a network via the network interface device 1122.

While the computer-readable storage medium 1124 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “identifying”, “providing”, “enabling”, “finding”, “selecting” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. A method comprising:
storing, by a processing device of a server, associations between a plurality of media playlists and a plurality of sponsored content items in a data store on a storage device, wherein a stored association is an association between an identifier of a media playlist of the plurality of media playlists and an identifier of at least one sponsored content item of the plurality of sponsored content items;
receiving, by the processing device, an sponsored content request pertaining to a media item, the media item being part of at least one media playlist of the plurality of media playlists, the sponsored content request comprising an identifier of the at least one media playlist;
obtaining, by the processing device, one or more sponsored content items of the plurality of sponsored content items that are associated with the identifier of the at least one media playlist for the media item based on the associations stored in the data store, each of the obtained sponsored content items having a performance score reflecting an association of a respective sponsored content with the at least one media playlist;
for each of the one or more sponsored content items:
determining, by the processing device, one or more additional associations with additional media playlists of the plurality of media playlists, other than the at least one media playlist;
adjusting, by the processing device, the performance score for the respective sponsored content item based upon the one or more additional associations with the additional media playlists; and
providing, by the processing device, the obtained one or more sponsored content items associated with the at least one media playlist for presentation with the media item according to adjusted performance scores of the obtained one or more sponsored content items.

2. The method of claim 1 further comprising:
selecting one or more of the plurality of media playlists; and
identifying one or more of the plurality of sponsored content items targeting the selected media playlists.

3. The method of claim 2 wherein selecting one or more of the plurality of media playlists comprises:
receiving sponsored content provider input specifying one or more media playlist characteristics; and
identifying the one or more of the plurality of media playlists that have characteristics matching the specified media playlist characteristics.

4. The method of claim 3 wherein the specified media playlist characteristics comprise at least one of a keyword and a category.

5. The method of claim 3 wherein the specified media playlist characteristics comprise at least one of a popularity indicator and a viewer demographic.

6. The method of claim 3 wherein the specified media playlist characteristics comprise at least one of a number of media items.

7. The method of claim 3 wherein the specified media playlist characteristics indicate whether media items in the media playlist are allowed to be presented with sponsored content items.

8. The method of claim 2 wherein the one or more of the plurality of sponsored content items targeting the selected media playlists are specified by sponsored content provider.

9. The method of claim 1 further comprising:
storing information identifying a creator of each of the plurality of media playlists;
determining a revenue generated by the provided sponsored content; and
providing a portion of the revenue to a creator of a corresponding media playlist.

10. (canceled)

11. The method of claim 10 wherein:
the sponsored content request is submitted by a content providing server when a user selects the media item from a media playlist presented to the user; and
the sponsored content request comprises an identifier of the media playlist presented to the user.

12. The method of claim 10 wherein:
the sponsored content request is submitted by a content providing server when a user submits a request for the media item independently of any media playlist; and
the sponsored content request comprises an identifier of each media playlist including the media item.

13. The method of claim 10 wherein the media item was added to the media playlist after an association between the media playlist and the provided sponsored content had been stored in the data store.

14. The method of claim 1 wherein storing the associations between the plurality of media playlists and the plurality of sponsored content items in the data store comprises:
for each media playlist, identifying media items included in the media playlist; and
storing, in the data store, an identifier of each of the identified media items together with an identifier of sponsored content associated with the media playlist.

15. The method of claim 14 wherein the sponsored content request identifies the media item but not the media playlist including the media item.

16. A computer implemented method comprising:
receiving, by a processing device, a user request for a media item;
identifying, by the processing device, one or more media playlists associated with the requested media item;
obtaining, by the processing device, one or more sponsored content items targeting the at least one identified media playlists for the requested media item, based on an association between an identifier of the at least one identified media playlist of the plurality media playlists and the identifier of the at least one sponsored content item of the plurality of sponsored content items, each of the obtained sponsored content items having a performance score reflecting an association of a respective sponsored content with the at least one media playlist;
for each of the one or more sponsored content items:
determining one or more additional associations with additional media playlists of the plurality of media playlists, other than the at least one media playlist;
adjusting the performance score for the respective sponsored content item based upon the one or more additional associations with the additional media playlists; and
causing at least one of the obtained one or more sponsored content items targeting the at least one identified media playlists to be presented along with the requested media item according to performance scores of the obtained one or more sponsored content items.

17. The method of claim 16 further comprising:
associating a plurality of media items with corresponding media playlists in a data store.

18. The method of claim 16 wherein receiving, at the computing device, the user request for the media item comprises:
receiving a user selection of the media item from a media playlist presented to the user.

19. The method of claim 18 wherein obtaining the one or more sponsored content items targeting the identified media playlists comprises:
sending, to a server, a sponsored content item request pertaining to the selected media item, the sponsored content item request comprising an identifier of the media playlist presented to the user.

20. The method of claim 16 wherein the user request for the media item is issued independently of any media playlist.

21. The method of claim 20 wherein obtaining the one or more sponsored content items targeting the identified media playlists comprises:
sending, to a server, a sponsored content item request pertaining to the media item, the sponsored content item request comprising an identifier of each media playlist including the media item.

22. A method comprising:
determining, by a processing device, whether a present sponsored content item for a media item is associated with an identifier of at least one media playlist; and
responsive to determining that the present sponsored content item for the media item is associated with the identifier of the at least one media playlist, predicting, by the processing device, a performance score of the present sponsored content item using data pertaining to the at least one media playlist.

23. The method of claim 22 wherein predicting the performance score of the present sponsored content item comprises:
incrementing the performance score of the present sponsored content item responsive to determining that the present sponsored content item is associated with the at least one media playlist.

24. The method of claim 22 wherein predicting the performance score of the present sponsored content item comprises:
estimating a popularity of the media item using one or more characteristics of the media item; and
adjusting the performance score of the present sponsored content item based on the popularity of the media item.

25. The method of claim 22 wherein predicting the performance score of the present sponsored content item comprises:
estimating a popularity of the at least one media playlist using characteristics of the at least one media playlist; and
adjusting the performance score of the present sponsored content item based on the popularity of the at least one media playlist.

26. The method of claim 22 further comprising:
prior to determining whether the present sponsored content item is associated with at least one media playlist, performing the following:
receiving, from a content providing server, an sponsored content item request comprising a set of parameters; and
identifying a plurality of sponsored content items using the set of parameters, the plurality of sponsored content items comprising the present sponsored content item.

27. The method of claim 26 further comprising:
comparing performance scores of the plurality of sponsored content items; and
providing one or more of the plurality of sponsored content items with higher performance scores to the content providing server.
